(19) United States
(12) Patent Application Publication
(10) Pub. No.: US 2014/0262739 A1
(43) Pub. Date: Sep. 18, 2014

(54) METHOD OF FORMING UNDERGROUND CAVERN AND DESALINIZATION PROCESS

(71) Applicant: LIGHTSAIL ENERGY, INC., Berkeley, CA (US)

(72) Inventors: Danielle A. FONG, Oakland, CA (US); Edwin P. BERLIN, JR., Oakland, CA (US); Stephen E. CRANE, Santa Rosa, CA (US); Andrea C. ASHWOOD, Oakland, CA (US); Sebastian C. MANCHESTER, Halifax (CA)

(73) Assignee: LIGHTSAIL ENERGY, INC., Berkeley, CA (US)

(21) Appl. No.: 14/162,653

(22) Filed: Jan. 23, 2014

Related U.S. Application Data
(60) Provisional application No. 61/778,257, filed on Mar. 12, 2013.

(51) Int. Cl. C02F 1/14; C02F 1/04

(52) U.S. Cl. CPC C02F 1/14; C02F 1/04
USPC 203/11; 203/10; 202/234; 202/233

(57) ABSTRACT

Embodiments relate to techniques for forming underground caverns, and also to desalinization processes that may be employed in conjunction therewith. Particular embodiments form a salt cavern by introducing heated water into a salt formation, followed by removal of the resulting brine to leave a salt cavern. The injected water is provided as a result of a desalinization process of the brine. Concentrated brine resulting from the desalinization process, is used to form a solar pond whose stored thermal energy provides the heat source for the injected water. The resulting underground cavern may be employed to house large volumes of materials such as pressurized natural gas, liquid hydrocarbons, or compressed gas for energy storage. Also disclosed is a particular desalinization process based upon a Regenerative Evaporative Distiller (RED) structure, which efficiently leverages low grade heat available from the solar pond by relying primarily upon a latent heat of evaporation and condensation.

### CROSS-REFERENCE TO RELATED APPLICATION

The instant nonprovisional patent application claims priority to the U.S. Provisional Patent Application No. 61/778,257, filed Mar. 12, 2013 and incorporated by reference in its entirety herein for all purposes.

### BACKGROUND

The availability of low-cost energy storage at utility scales would address a number of issues relating to the energy grid. In particular, the deployment of renewable power generators, such as wind and solar, may be limited by a difficulty in these technologies providing a reliable supply of power at predictable times or during periods of high demand.

Energy storage systems utilizing compressed gas as a storage medium, can allow for the effective use of renewable power generators. Such energy storage systems may rely upon underground caverns for the storage of large volumes of compressed gas.

### SUMMARY

Embodiments relate to techniques for forming underground caverns, and also to desalinization processes that may be employed in conjunction therewith. Particular embodiments form a salt cavern by introducing heated water into a salt formation, followed by removal of the resulting brine to leave a salt cavern. The injected water is provided as a result of a desalinization process of the brine. Concentrated brine resulting from the desalinization process, is used to form a solar pond whose stored thermal energy provides the heat source for the injected water. The resulting underground cavern may be employed to house large volumes of materials such as pressurized natural gas, liquid hydrocarbons, or compressed gas for energy storage. Also disclosed is a particular desalinization process based upon a Regenerative Evaporative Distiller (RED) structure, which efficiently leverages low grade heat available from the solar pond, by relying primarily upon a latent heat of evaporation and condensation.

### BRIEF DESCRIPTION OF THE DRAWINGS

FIG. 1 is a simplified schematic view illustrating a method of forming an underground cavern according to an embodiment.

FIGS. 2A-E illustrating an embodiment of an apparatus for performing a desalinization process.

FIG. 3 is a perspective view illustrating an alternative embodiment of an apparatus for performing a desalinization process.

FIG. 4 is a simplified schematic view illustrating an embodiment of an energy storage and recovery system.

FIG. 5 is a cross-sectional view illustrating an alternative embodiment of an apparatus for performing a desalinization process.

FIG. 6 is a perspective view illustrating an alternative embodiment of an apparatus for performing a desalinization process.

FIG. 7 shows an embodiment of a device comprising a solid wicking material introduced to a flow channel to encourage liquid flow.

FIG. 8 shows a side view of an embodiment of a heat and mass exchanger apparatus that relies upon liquid flowing only through a porous wick. FIG. 8A shows a perspective view of the embodiment of FIG. 8.

FIG. 9 shows a perspective view of an embodiment of a low flow manifold. FIG. 9A shows an enlarged cross-sectional view of one liquid outlet of the manifold of FIG. 9.

FIG. 10 shows an embodiment wherein a liquid flow channel features enhanced surfaces roughened in a direction orthogonal to a flow direction.

FIG. 11 shows a simplified cross-section of a flow channel that includes a crump.

FIG. 12 shows a simplified view of one embodiment of an apparatus including step-like feature to control a flow rate in conjunction with gravity feed.

FIG. 13 shows a corrugated head space surface creating baffles that funnel condensed liquid to drip from the head space into the channel configured to receive the distillate flow.

FIG. 14 shows an embodiment of a RED device featuring liquid introduction in a manner including a component countering resistance offered by surface tension within a channel.

FIG. 15 plots mass gained versus ambient pressure for numerical modeling of an embodiment.

### DESCRIPTION

Underground caverns may be useful in storing large volumes of certain materials, such as gases. Conventionally, one technique for forming underground caverns is to introduce pressurized heated water at a depth within a naturally-occurring salt formation such as a salt dome or bedded salt deposit. The salt of the formation becomes dissolved in the water to form brine, creating a cavity. The brine may then be flowed from the cavity to form the cavern.

Such conventional approaches to underground cavern formation may offer certain drawbacks inhibiting their adoption. One potential difficulty is the consumption of energy to heat the water that is used to dissolve the salt. Often, fossil fuels are burned for this purpose, adding cost and introducing carbon into the atmosphere.

Another potential drawback of conventional approaches is the expense associated with having to drill multiple wells into the ground. Specifically a first well is used to introduce the heated water underground. A second well may be used to recover water from an aquifer, but it is also possible to use water from a river or municipal supply, or even have the water be trucked in to the site. A third well may be used to reject the waste brine, but the first well may also be used for this purpose.

Still another potential drawback associated with conventional approaches, is environmental contamination. In particular, owing to the high concentration of dissolved salt present in the extracted brine, it may have deleterious effect on plants and animals and hence must be remediated or kept segregated from the surrounding environment.

Embodiments as described herein relate to methods of forming underground caverns that obviate one or more drawbacks mentioned above. In particular, embodiments employ cavern formation in conjunction with a desalinization process driven by heat from a solar pond that is created from extracted brine. The extracted brine is subjected to a desalinization process resulting in greater concentration of salt. At the same time, the desalinization process lowers a concentration of salt in another water source.

The concentrated brine may then be flowed to a solar pond that is used to store thermal energy. Thermal energy from the solar pond may be harnessed to drive one or both of the desalinization process and/or heating of the water introduced for cavern formation.

FIG. 1 is a simplified schematic view illustrating a system of forming an underground cavern according to an embodiment. System 100 comprises a first well 102 that is drilled to contact a naturally-occurring salt formation 104. Heated water 106 is pumped into first well 102, where it enters the salt formation and begins to dissolve the solid contents thereof. As a result of this process, a salt cavern 108 is formed.

Brine 110 containing the dissolved salts exits the cavern via a second well 112 that leads to the surface. At the surface, the brine is exposed to a desalinization process 114.

Water with low salt content may be provided to the desalinization process an initial or ongoing additional input 190. A variety of water sources can be used for this purpose, including but not limited to: aquifer wells, municipal/existing plumbing sources, rivers, and water transported in by ground (e.g. pipeline, by road).

As a result of this desalinization process, low salinity water 116 with low or negligible salt concentration is produced.

Concentrated brine 118 is also produced as a result of this desalinization process. The concentrated brine is flowed from the second well into a solar pond 120.

Solar pond 120 comprises a body of water in which low salinity water floats on top of high salinity water. As a result of the increasing salinity gradient, solar energy penetrating into the lower depths of the solar pond becomes trapped therein. The temperature gradient is in the opposite direction as the salinity gradient, and the surface of the solar pond remains cool and evaporation is minimally enhanced by the stored thermal energy.

The thermal energy 130 stored within the solar pond, is communicated (e.g. via a heat exchanger 132) to the diluted water 116 from the desalinization process, to form the heated water 106. This is the heated water that is injected into the ground for purposes of cavern formation.

Alternatively, or in conjunction with heating water for injection, the thermal energy from the solar pond could also be communicated to drive the desalinization process.

While FIG. 1 describes formation of a cavern, one or more additional desirable end products may result from this process. One such end product is salt or other mineral dissolved in the water, which may be harvested and refined from the brine or concentrated brine. Examples of such minerals include but are not limited to lithium and phosphorous.

Another potentially useful end product of the process of FIG. 1, is the low or negligible saline water resulting from the desalinization process. Once the cavern is created to a satisfactory size, such water may be used for drinking water and/or irrigation purposes.

Still another potentially useful end product of the process of FIG. 1, is the heat from the solar pond. In particular, heat from the solar pond created from the brine of the cavern, may be harnessed for a variety of purposes, including but not limited to facilities heating or use in chemical processes.

Finally, it is noted that once the solution mining is completed, there will exist an underground cavern and a salt pond at the surface. This combination of elements could be used for pumped hydro energy storage.

Specifically, water flowing from the pond through a (perhaps) re-purposed drill shaft through a pump/motor operating as a motor, into the cavern, would generate power. The same device operating as a pump could send the brine back up to the pond, thereby storing power.

In such an embodiment, the pond may no longer be useful for thermal storage. Accordingly, an alternative embodiment could utilize a second cavern located at a different depth below the ground for such hydro energy storage, instead of a salt pond at the surface. Such an embodiment could be desirable if a permanent salt pond is not wanted, or if the solar pond is desired to be retained for use.

Embodiments of cavern-forming techniques as in FIG. 1, are not limited to use with any particular desalinization process. A variety of desalinization techniques are known, including but not limited to those relying upon filtration and/or the use of phase change of the water (e.g. boiling/distillation/humidification/dehumidification). Such desalinization techniques may vary in such parameters as intensity of energy consumption.

It is noted that the thermal energy collected and stored by solar ponds, is typically relatively low-grade in nature (e.g. <˜100° C.). To significantly exceed that temperature would create bubbling in the solar pond, disrupting the salinity gradient necessary for its operation.

Accordingly, described now in connection with the FIGS. 2A-2E, are embodiments of a specific desalinization approach that can efficiently leverage the low-grade heat available from a solar pond.

In particular, embodiments of desalinization approaches as described herein may utilize some amount of specific heat (ΔT) transferred from the solar pond, the bulk of which drives desalinization processes which evaporate and condense water. As described below, this may be accomplished utilizing a structure referred to herein as a Regenerative Evaporative Distiller (RED).

FIG. 2A shows a simplified schematic view of a desalinization apparatus employing a RED according to an embodiment. The desalinization apparatus 200 comprises a pair of channels 202 and 204, through which different liquids A and B flow in opposite directions.

The desalinization apparatus is demarcated into a first region I and a second region II, by the location (X=0) of a source of specific heat 203. The first region I comprises a counter-flow heat exchanger in which heat, but not mass, are configured to be transferred between the flowing liquids.

The second region II comprises the RED. In the RED, the both heat and mass are transferred between the flowing liquids. In particular, as shown in the simplified cross-section of FIG. 2D, the two liquid flow channels 202 and 204 are enclosed within a sealed region 205 and share a same head space. As a result, a mass of water evaporating (shown by curved dashed lines) from one channel, may condense and be transferred to liquid in the second channel. FIG. 2E shows a perspective view of this mass transfer, omitting the sealed region for purposes of illustration.

In some embodiments, the head space may be at substantially at the same, atmospheric or near atmospheric pressure along its entire flowing length. In particular embodiments, partitions (see FIG. 3 below) and/or other surfaces within the head space are coated in a hydrophobic coating, to prevent condensation. According to some embodiments, solid surfaces in region II may be thermally insulating.

Returning to FIG. 2A, that view shows a particular embodiment wherein the flow A entering at one (left) side of the desalinization structure, comprises brine as may be a product of a cavern formation process. The flow B entering at the opposite (right) side of the desalinization structure, comprises a water source having a significantly lower dissolved salt content than A.

Application of the specific heat ΔT to the brine flow A at point X=0, initiates a desalinization process. FIG. 2B plots corresponding temperature of the liquid flows A and B over the length of the desalinization structure.

In particular, heating of the flow A causes the evaporation of water therefrom in the RED of Region II. This evaporated water condenses in the opposite flow B in the Region II, owing to its lower temperature. Depending on the concentration of salts and dissolved minerals, the ΔT necessary to drive this net evaporation from the saline stream and distillation in the pure stream will differ, as water molecules have differing affinities for one another in the presence of certain dissolved salts and minerals.

Due to the mass transfer of water occurring in the RED, the salt content in the flow A becomes concentrated, while the water mass of flow B increases. If flow B has any salt concentration to speak of initially, it becomes further diluted. Thus in FIG. 2A, the water flowing in the top leftward direction starts out as desalinate water, and more (in L/s) desalinated water flows in that direction at the top.

FIG. 2C plots salinity of the flows A and B over the length of the desalinization structure, showing this effect. As noted in the FIG. 2C, it is not required for the flow B to have any initial salinity for the desalinization process to take place.

The latent heat associated with this transfer of mass may contribute the bulk of the thermal energy transfer in region II. Here, the ratio of sensible heat capacity of the fluid to the latent heat capacity, is related directly to the fraction of evaporated water to transported water possible in each pass. The counter-flowing stream of water can be of approximately equal mass flow in to the device, as the evaporated, saline stream of water flow out of the device. Such a configuration may realize thermodynamically efficiency.

The desalinization structure of FIGS. 2A-E represents one particular embodiment, and variations are possible. For example, FIG. 3 shows an alternative embodiment featuring a partition 300 extending into the enclosed space overlying the liquid flows. This partition serves to constrain the movement of gas in the head space, and thus confine the location of specific evaporation and condensation events along the length of the RED.

The partitions segregating air regions of the evaporating and condensing water may be thermally insulating. The air gap can be designed to assist convection (specifically convection rising from the evaporator). The water depth in any part of the evaporator or condensor may be minimized, in order to minimize heat transfer along the water's flow direction.

While the specific embodiment of FIGS. 2A-2E involves the communication of specific heat restricted to the point X=0, this is not required. Accordingly, the alternative embodiment of FIG. 3 also includes certain heat conduction structures 302 that are configured to communicate heat between the liquid flowing in the channels.

As shown, a heat conduction structure 302 may extend to transfer heat to a portion of the corresponding opposite liquid flow located directly across therefrom. As also shown in FIG. 3, a heat conduction structure 302 may extend to transfer heat to a portion of the corresponding opposite liquid flow located upstream or downstream.

The particular linear layout of the distillation structure of FIG. 2A is provided as an example, and embodiments are not limited thereto. Alternative embodiments could feature counter-flowing liquids within channels arranged according to other embodiments, including but not limited to concentric, spiral, helical, interdigitated, and others.

According to embodiments, the flow of evaporating or condensing water can be horizontal or nearly so. This contrasts with many conventional humidification/dehumidification cycles that are vertical in nature (e.g. using cooling towers, etc.) Where liquid flows are gravity fed, near-horizontal embodiments configurations are possible utilizing very shallow slopes.

It is also noted that in alternative embodiments, the counterflow heat exchanger exchanging heat from liquid to liquid, could be included in the evaporator condenser. In one embodiment 600 shown in simplified form in FIG. 6, the condensor 602 is a thermally conductive trough, with a pipe 604 containing salty water 605 running directly beneath it. The salty stream in the pipe is flowing counter to the salty stream in the evaporating trough 606. As the water evaporates out of the evaporator, it condenses on the trough.

That use of the stream of low or negligible salinity water (flow B) as a heat transfer medium in FIG. 2A, is not required in all embodiments. In practice, a design tradeoff may exist.

Specifically, the embodiment of FIG. 2A includes a separate evaporator/distiller (Region II) and a separate counterflow heat exchanger (Region I). A low-salt stream of water (flow B) is used to transfer latent heat from the condensation, to the brine stream (flow A).

Such a design calls for more circulation of water, and involves more devices. However, a benefit is that the evaporator/distiller can be made partly or solely of insulating material, and the counterflow heat exchanger can be cost effective to maintain as a separate device.

As described above, the RED device may utilize liquid flow through adjacent channels that may be of small size. Under such circumstances, flow may be inhibited by the surface tension of the liquid within the channel.

Accordingly, in order to encourage liquid flow and avoid stagnation, certain embodiments may introduce a solid wicking material to the channel. As shown in FIG. 7, the presence of the wicking material 700 within the liquid flow 702 of the channel 704, may promote liquid flow from an inlet 706 to an output 708 for purposes of heating or receiving distillate material.

The wick may function to promote flow according to one or more of at least four separate underlying physical mechanisms:

disruption of surface tension within the liquid;

gravity;

a siphon (also “syphon”) effect arising from a pressure differential;

capillary action.

Each of these mechanisms is now discussed in turn.

As mentioned above, the presence of the physical wick within the channel with the liquid, may disrupt surface tension that causes the water to pool. Such surface tension can play a particularly large role in inhibiting flow and low flow rates. The wick effectively breaks the surface tension of the water and prevents it from pooling.

Under a second separate mechanism, gravity can act on the liquid to move it from a first (higher) location relative to the center of the earth, relative to a second (lower) location. Such a situation may occur where the liquid inlet is at a greater height than the liquid outlet.

Under a third separate mechanism, a siphon effect may act on the liquid to move it from a first (high pressure) environment to a second (lower pressure) environment. A difference in a height of the liquid in a conduit hose drives the action. Gravity pulls on the lower part of the liquid, and all the liquid moves. Otherwise, a gap would open up, creating a vacuum, and the section of liquid that has vacuum on one side and air pressure on the other will move to close the gap. A siphon can pull a fluid in any direction, as long as it follows a pressure gradient. For example, a siphon action can pull a fluid up 1 meter, and then down 2 meters. By contrast, gravity flow is limited to moving a fluid in a downward direction.

Under a fourth separate mechanism, a wicking action and/or capillary effect may act on the liquid to move it from one location to another. This wicking action is based upon intermolecular forces between the liquid phase and the surrounding solid phase (e.g. the wick itself). In particular, the solid wick comprises a plurality of pores configured to receive the liquid and offering a large surface area to define a liquid-solid interface. Forces operating at that liquid-solid interface can operate to flow the liquid through the wick in a particular direction.

Depending upon the specific application, the wick may comprise any number of different types of porous materials. Owing to the relatively high uniformity of porosity exhibited by natural products such as cotton, wool, flax, hemp, or others, those materials may be favored to serve as wicks. However this is not required, and artificial porous materials (such as polyester or others) could alternatively be employed to perform a wicking function.

The following table lists the four different mechanisms that may operate independently to provide a liquid flow.

| MECH- | |
|---|---|
| ANISM | FACTORS |
| Liquid | • channel volume • channel surface area • channel |
| Surface | material (e.g. polarity) • channel coating • liquid |
| Tension | material (e.g. polarity) |
| | • wick dimension |
| Gravity | • vertical distance between liquid inlet and outlet |
| | • liquid material |
| Siphon | • pressure difference between liquid inlet and outlet |
| | • liquid material |
| Wicking | • wick cross-section • wick porosity • wick material |
| Action | • liquid material |

This table also indicates the various factors that may influence the magnitude of the liquid flow.

It is further noted that certain embodiments may dispense with separate channel(s) entirely, relying instead upon the transfer of heat and mass between liquid flows taking place through the solid wicking materials under the influence of gravity, siphon, and/or wicking action. One example of such an embodiment is shown and described in connection with FIGS. 8-8A.

In particular, FIG. 8 shows a side view of one embodiment of a heat and mass exchanger apparatus 800 that relies upon liquid flowing only through porous wick(s). FIG. 8A shows a perspective view of the embodiment of FIG. 8.

Specifically, device 800 transfers heat and mass from a hot liquid stream 802 flowing through a first wick 804, and a cold liquid stream 806 flowing through a second wick 808.

In the device of FIGS. 8-8A, liquid is transported using a combination of both wicking action and gravity (e.g. the liquid flows through the wick(s) in a downward direction). As shown by the arrows 810, evaporate from the hot stream condenses onto, and transfers mass to, the cold stream.

A solid but porous wick structure may also be useful to evenly distribute liquids at low flow rates, where pressure is not sufficient to adequately drive the liquid streams. For example, as mentioned above, sub-division of streams into low flow rates may be inhibited by surface tension.

Accordingly, FIG. 9 shows an embodiment of a low flow manifold 900 comprising a reservoir 902 configured to holding a volume of liquid 904 received from an inlet 906. The reservoir 902 defines a plurality of liquid outlets 908.

FIG. 9A shows an enlarged view of one liquid outlet. In particular, the device uses wicking action to draw liquid from the reservoir into the outlets through a plurality of wicks 910. In this particular embodiment, the wick may comprise a cotton string, but this is not required for all possible embodiments.

FIG. 9A further shows that shows an enlarged view of one liquid outlet. In particular, the device 900 utilizes a flow restrictor 912 at the outlets to control flow therefrom. Here, the flow restrictor 912 may comprise a knot in the wick, which in this particular embodiment serves to fully occupy the opening of the outlet, such that liquid flows from the reservoir into the wick according to the desired forces (e.g. capillary, wicking, gravity, siphon). In other embodiments, the knot may not fully occupy the outlet opening.

It is further noted that forces may be applied to control the thermal and mass exchange occurring between the liquid streams. For example, in certain embodiments an electric potential difference could be caused to arise between the liquid flows. In some embodiments, this potential difference could be applied from a power supply to electrodes present in the liquid flow channels. Alternatively the potential could be applied directly to the channels themselves or to wick(s) present therein, or to just the wick(s) if used without channel(s).

The resulting electric field could promote the movement of mass between the liquid flows. For example, water evaporating from a warm channel could be drawn by the field in the direction of the colder channel, thereby establishing an enhanced flow.

It is further noted that the application of a potential difference may also promote heat transfer by disrupting thermal boundary layers that can arise in the liquid. Such enhanced thermal transfer will also aid in evaporation resulting from the heating of the liquid flow.

Another possible force that could be applied to control distillation performance, is a reduction in gas pressure in the space overlying the liquid flows. In particular, imposition of reduced pressure in the head space (e.g., using a vacuum pump or other element) could promote evaporation, enhancing the rate of distillation in a manner similar to that described below in connection with FIG. 5.

A numerical model of the RED system indicates that, for the same inlet conditions, a reduction in gas pressure increases the amount of water obtained from RED. FIG. 15 plots mass gained versus ambient pressure for numerical modeling of an embodiment. As this figure illustrates, a reduction of air pressure by half yields 44% more water mass per day. In certain embodiments, such a reduction in pressure would be expected to consume only about 5 W of pumping power.

Physical features may also serve to control liquid flows and distillation resulting therefrom. FIG. 10 shows an embodiment wherein a liquid flow channel 1000 features enhanced surfaces 1002 that have been specifically roughened in a direction 1004 orthogonal to the flow direction 1006. Such an enhanced surface can serve to disrupt surface tension and thermal boundary layers. Examples of processes that can give rise to roughening can include but are not limited to roll forming, stamping, sintering, and corrugating.

Physical features other than roughening may be used. One example is a crump feature used in weirs of aqueducts in order to control liquid flow. In particular, FIG. 11 shows a simplified cross-section of a flow channel 1100 that includes a crump 1102. The leading edge 1102a of the crump relative to the liquid flow, may serve to build pressure at constriction point C, with that pressure released in a controlled manner beyond the constriction point C. In this manner, flow rates within the channels could be controlled utilizing spatial features.

Another example of a physical feature used for distillation, could include a step-like feature configured to control a flow rate in conjunction with gravity feed. FIG. 12 shows a simplified view of one embodiment.

In particular, RED device 1200 of FIG. 12 comprises a gravity-fed flow 1202 along a first surface 1204 including a plurality of step features 1206. The liquid flowing along the surface conforms to the step profile.

Thermal and mass transfer takes place between the gravity-fed flow 1202 and a second flow 1210 moving in an opposite direction. Here, the second flow is driven by a siphon effect, but this is not required and other forces (including combinations thereof) could drive the second liquid flow. While the particular embodiment of FIG. 12 shows mass transfer occurring between liquid streams flowed in opposite directions, this is not required and in some embodiments the liquid streams could flow in the same direction.

Physical features within the head space enclosing liquid flows, could also serve to influence the nature of the distillation process. This is shown in FIG. 13, where the corrugated head space surface 1300 serves to create baffles funneling condensed liquid 1302 to drip from the head space into the channel 1304 that is configured to receive the distillate flow. A roughened head space surface could also serve to provide nucleation sites for the condensation of evaporated liquid within the head space.

Finally, it is noted that the manner of introduction of liquid for flow, may calculated to promote higher flow rates. For example, FIG. 14 shows a simplified view of an embodiment of a RED device 1400 comprising a reservoir 1402 from which liquid is flowed along the X-direction through a channel 1404.

Where the channel is narrow, surface tension may inhibit the flow rate. Such surface tension, however, may be counteracted by introducing the liquid to the reservoir (e.g. by pumping) in a direction Vp, where Vp intentionally includes a component (V_{X}) lying along the X-axis. That component forces the liquid down the channel, thereby overcoming a resistance offered by surface tension.

Returning now to FIG. 2A, as mentioned above another benefit of the embodiment of that figure is that it provides a low saline water stream that is ready made for heating and injection for cavern formation according to the approach of FIG. 1. Such a cavern may prove suited for the storage of energy in the form of compressed gas, as is now discussed in connection with FIG. 4.

FIG. 4 is a simplified schematic view illustrating an embodiment of an energy storage and recovery system. Energy storage and recovery system 400 comprises two subterranean cavities 402 and 404, with the volume V1 of the cavern 402 being substantially larger that the volume V2 of the cavern 404. Alternatively, the caverns could be a same size, but store gas at substantially different pressures. One or both of the caverns may be formed utilizing the approach of the embodiments of FIGS. 1 and 2A, although this is not required.

The caverns are in selective fluid communication with one another through conduit 410 and surface compressor/expander (C/E) 420, that is in communication with a motor/generator (M/G) 430. Operation of the system of FIG. 4 is now described.

In an energy storage mode, the motor/generator functions as a motor, driving the compressor/expander as a compressor to compress and flow gas from the large chamber for storage at high pressure in the smaller chamber. Such a storage mode could occur during off-peak hours, for example.

In an energy recovery mode, the motor/generator functions as a generator driven by the compressor/expander operating as an expander. In particular, the gas stored at high pressure in the smaller cavern is flowed through the compressor/expander, where its expansion drives the expander and results in the generation of electricity by the generator. Such an energy recovery mode could occur during peak electricity consumption hours, when electrical prices are at a premium.

In certain embodiments, gas compression and/or expansion may take place in an adiabatic manner. Such embodiments may benefit from economies of scale resulting from the compression and expansion of relatively large gas volumes (e.g. about 100 m³ to about 1,000,000 m³) to relatively low maximum pressures (e.g. about 10 atmospheres to about 300 atmospheres). Such embodiments may also benefit from the use of existing compression and expansion technologies.

Alternatively, embodiments may perform gas compression and/or expansion in a manner that is isothermal or near-isothermal. Such operation may confer enhanced efficiency according to certain thermodynamic principles.

In some embodiments, it is possible for the compressor/expander to perform in a near-isothermal manner. Incorporated by reference herein for all purposes is U.S. Patent Publication No. 2011/0115223 (“the Publication”), which is incorporated by reference in its entirety herein for all purposes. According to the Publication, gas may be compressed in the presence of liquid water as a heat exchange medium. That is, heat generated from the compression of gas is transferred across a gas-liquid boundary (e.g. fine droplets), such that the temperature experienced by the gas remains within a relatively small range over the course of the course of the compression cycle. This enhances the thermodynamic efficiency of the compression process. The transferred heat of gas compression may be retained in the heated water, and may be available for other uses.

A compressor as described in the Publication, may utilize a reciprocating or rotating moveable member for gas compression. An example of the former is a solid piston connected to a mechanical linkage comprising a piston rod and rotating shaft (e.g. crankshaft), and incorporated by reference herein for all purposes is the U.S. Patent Publication No. 2013/0098027. An example of the latter is a rotating turbine, screw, or other structure connected to a mechanical linkage comprising a rotating shaft, and incorporated by reference herein for all purposes is the U.S. Patent Publication No. 2013/0192216.

In certain embodiments as described in the Publication, liquid may be introduced directly into the compression chamber for heat exchange. In certain embodiments, liquid may be introduced to gas in a mixing chamber upstream of the compression chamber.

It is noted that the isothermal or near-isothermal compression/expansion as described in the Publication, has potential applicability to desalinization as discussed in connection with FIG. 1. FIG. 5 shows a simplified view of such an apparatus that may be used both for compressed gas energy storage, and also desalinization.

Specifically, in the apparatus 500 of FIG. 5, the source of gas for the reciprocating compressor/expander 502 comprises the head space 504 overlying salt water 505. Operation of the compressor creates near vacuum conditions in the head space, lowering the boiling point of the salty water and allowing water to evaporate and enter the compression chamber. This water vapor mixes with liquid water sprayed from a tank for purposes of heat transfer during compression.

In certain embodiments, waste heat and or heat of condensation may be recycled into the salty water to aid evaporation. Alternatively, atmospheric heat may be added to the salty water to prevent it from growing too cold. As another possible variation, air may be largely excluded from the head space.

According to still another possible variation, instead of a sealed container as a source of gas for the compressor, atmospheric air is taken in. However, before the air enters the compressor, it passes through an evaporator, which could be an evaporation pan or an evaporation tower. The evaporator both cools the air (increasing thermodynamic efficiency) and concentrates the brine.

Separation of the liquid from the compressed gas occurs in separator 550, with the resulting compressed gas being stored in storage unit 552. Storage unit 552 may be an underground cavern, and that underground cavern may be formed as a result of the process of FIG. 1. A side product of the compression is the accumulation of desalinated water 556 within vessel 555.

Large underground caverns, the formation of which has been described herein, may be used to contain a variety of materials. As described above in connection with FIG. 3, one material which may be contained is compressed gas for use in energy storage systems. One type of compressed gas is air, but others could be housed, including but not limited to nitrogen, carbon dioxide, helium, hydrogen, and others.

Underground caverns created according to embodiments may offer particular value in the storage of compressed natural gas at elevated pressure, as well as of compressed natural gas stored at supercritical pressure (hereafter referred to as “supernatural” gas). In particular, the caverns may offer a repository accommodating large quantities natural gas over the course of long- or short-term swings in market price therefor, allowing for an owner to wait until prices rise in order to recoup an initial drilling investment.

In fact, sales of futures in the natural gas that is to be initially stored within an underground cavern, could even provide the mechanism for financing the cost of constructing the cavern itself. Once the natural gas is sold, the cavern that remains could thereafter be employed at a profit for the storage of various materials (e.g. compressed air).

While the previous discussion has focused upon the storage of materials in the gas phase, embodiments are not limited to this. Underground caverns could store a variety of liquid (or even solid) materials, including but not limited to hydrocarbons and derivatives thereof.

In conclusion, it is noted that the RED embodiments shown and described in FIGS. 2A-3, is not limited to use in connection with desalinization. In particular, the counterflow evaporation/condensation techniques involving mass and heat transfer driven primarily by latent heat, could be applicable to other chemical processes involving distillation.

For example, the liquid is not necessarily water.

Moreover, it is understood that the concentration being distilled away from need not necessarily be dissolved solid, but could be other fluids. Embodiments could be used in the fractional distillation of oils or alcohols. Accordingly, embodiments could be employed in the refining of petroleum products, for example.

1. A method comprising:

applying thermal energy to heat water;
introducing the heated water into a geological formation;
causing the heated water to dissolve a portion of the geological formation and form a cavern;
extracting brine from the cavern;
exposing the brine to a desalinization process to produce the water and a concentrated brine; and
forming a solar pond from the concentrated brine, wherein the thermal energy is stored in the solar pond.

2. A method as in claim 1 further comprising harvesting a dissolved mineral from the concentrated brine.

3. A method as in claim 1 wherein the desalinization process employs a Regenerative Evaporative Distiller (RED) involving mass transfer and heat transfer.

4. A method as in claim 3 wherein the desalinization process employs the RED in conjunction with a counterflow heat exchanger involving heat transfer.

5. A method as in claim 1 wherein the desalinization process creates a vacuum environment over the brine.

6. A method as in claim 1 wherein the desalinization process is driven by the thermal energy stored in the thermal pond.

7. A method as in claim 1 further comprising storing a material in the cavern.

8. A method as in claim 7 wherein the material comprises natural gas.

9. A method as in claim 7 wherein the material comprises compressed air.

10. A method as in claim 7 wherein the material comprises a hydrocarbon.

11. A method comprising:

in an energy storage phase,
storing gas in a first underground cavern at a first pressure,
compressing the gas to a second pressure higher than the first pressure, and
flowing the compressed gas to a second underground cavern; and
in an energy recovery phase occurring after the compression phase,
causing the compressed gas to expand in an expander and drive a generator, and
flowing the gas from the expander to the first underground cavern.

12. A method as in claim 11 wherein the gas comprises air.

13. A method as in claim 12 wherein the second pressure is at least 10 bar higher than the first pressure.

14. A method as in claim 12 wherein a volume of the first underground cavern is at least 2× greater than a volume of the second underground cavern.

15. A method as in claim 11 wherein at least one of the first underground cavern and the second underground cavern are formed by introducing desalinated water heated by a solar pond, into a salt formation.

16. A method as in claim 11 wherein compressing the gas comprises compressing the gas under adiabatic conditions.

17. A method as in claim 11 wherein compressing the gas comprises compressing the gas in the presence of a liquid for heat transfer.

18. A method as in claim 11 wherein the compressed gas is expanded under adiabatic conditions.

19. A method as in claim 11 wherein the compressed gas is expanded in the presence of a liquid for heat transfer.

20. A method comprising:

providing a first channel in gaseous communication with a second channel through a common head space
causing a first liquid to flow through the first channel in a first direction;
causing a second liquid to flow through the second channel in a second direction opposite to the first direction; and
applying specific heat to cause evaporation in the second channel and condensation in the first channel.

21. A method as in claim 20 wherein the specific heat is applied between:

a Regenerative Evaporative Distiller (RED) structure comprising the first and second channels and allowing both mass transfer and thermal transfer; and
a counterflow heat exchanger containing the first and second liquids and allowing only thermal transfer.

22. A method as in claim 20 wherein the specific heat is provided from a solar pond.

23. A method as in claim 20 wherein:

the first liquid comprises a first aqueous solution; and
the second liquid comprises a second aqueous solution.

24. A method as in claim 23 wherein:

the first aqueous solution comprises brine; and
the second liquid comprises a dilute aqueous solution.

25. A method as in claim 20 wherein the first liquid and/or the second liquid are flowed at least partially by gravity.

What is claimed is:

1. A method comprising:
providing a first liquid stream flowed in a first direction, in gaseous communication through a common head space with a second liquid stream flowed in a second direction opposite to the first direction; and
applying specific heat to cause evaporation in the second channel and condensation in the first channel.

2. A method as in claim 1 wherein the first liquid stream is flowed through a channel.

3. A method as in claim 1 wherein the first liquid stream is flowed through a wick.

4. A method as in claim 1 wherein the specific heat is applied between:
a Regenerative Evaporative Distiller (RED) structure comprising the first and second liquid streams and allowing both mass transfer and thermal transfer; and
a counterflow heat exchanger containing the first and second liquid streams and allowing only thermal transfer.

5. A method as in claim 1 wherein the specific heat is provided from a solar pond.

6. A method as in claim 1 wherein:
the first liquid stream comprises a first aqueous solution; and
the second liquid stream comprises a second aqueous solution.

7. A method as in claim 6 wherein:
the first aqueous solution comprises brine; and
the second liquid stream comprises a dilute aqueous solution.

8. A method as in claim 6 wherein:
the first aqueous solution comprises brine; and
the second liquid stream comprises potable water.

9. A method as in claim 1 wherein the first liquid stream is flowed at least in part by gravity.

10. A method as in claim 1 wherein the first liquid stream is flowed at least part by siphon action.

11. A method as in claim 1 wherein the first liquid stream is flowed at least part by capillary action.

12. A method as in claim 1 further comprising applying an electrical potential difference between the first liquid stream and the second liquid stream.

13. A method as in claim 1 further comprising reducing a pressure of the common head space.

14. An apparatus comprising:
a first liquid stream flowed in a first direction, in gaseous communication through a common head space with a second liquid stream flowed in a second direction opposite to the first direction; and
a source of specific heat configured to cause evaporation in the second channel and condensation in the first channel.

15. An apparatus as in claim 14 further comprising a channel to receive the first liquid stream.

16. An apparatus as in claim 14 further comprising a wick to receive the first liquid stream.

17. An apparatus as in claim 14 wherein:
a Regenerative Evaporative Distiller (RED) structure comprises the first and second liquid streams and allows both mass transfer and thermal transfer; and
the apparatus further comprises a counterflow heat exchanger containing the first and second liquid streams and allows only thermal transfer.

18. An apparatus as in claim 14 wherein the first liquid stream is flowed by gravity.

19. An apparatus as in claim 14 wherein the first liquid stream is flowed by siphon action.

20. An apparatus as in claim 14 wherein the first liquid stream is flowed by capillary action.

21. An apparatus as in claim 14 further comprising a power supply configured to apply a potential difference between the first liquid stream and the second liquid stream.

22. An apparatus as in claim 21 further comprising an electrode.

23. An apparatus as in claim 14 further comprising an element configured to reduce a pressure in the head space.

24. An apparatus as in claim 14 further comprising a partition projecting into the head space.
